(19) United States
(12) Patent Application Publication
(10) Pub. No.: US 2010/0235138 A1
(43) Pub. Date: Sep. 16, 2010

(54) Engine Flexible Drive Elongation Measurement

(76) Inventors: Zbyslaw Staniewicz, Barrie (CA); Terry P. Cleland, Pickering (CA); Gary J. Spicer, Mississauga (CA); Jacek Stepniak, Innisfil (CA)

Correspondence Address: MAGNA INTERNATIONAL, INC., 337 MAGNA DRIVE, AURORA, ON, L4G-7K1, CA

(21) Appl. No.: 12/304,027

(22) PCT Filed: Jun. 13, 2007
(86) PCT No.: PCT/CA07/01038

§ 371 Date: Dec. 12, 2008

Related U.S. Application Data
(60) Provisional application No. 60/813,330, filed on Jun. 13, 2006.

(51) Int. Cl. G01M 13/02; G01B 5/02; G08B 21/00

(52) U.S. Cl. 702/151; 702/158; 340/681

(57) ABSTRACT

A system and method is provided for determining changes in the angular position of a driven pulley, with respect to a driving pulley, when the driven and driving pulleys are synchronously linked by a flexible drive member such as a toothed belt or a chain. From these determined changes in the angular positions, the system and method can determine the condition of the flexible drive member and can output an appropriate signal when the condition of the flexible drive member has exceed a pre-defined value. Further, the system and method can detect a variety of other undesired conditions in the operation of an engine and/or the relative angular position information can be used to alter operation of the engine to improve the engine's operating efficiency and/or reduce the emissions created during operation of the engine.

### FIELD OF THE INVENTION

The present invention relates to a method and system for determining the elongation of a flexible drive member in a synchronous drive. More specifically, the present invention relates to a system and method for determining the elongation, which occurs with wear and aging, of a flexible drive member comprising a flexible belt or chain in a synchronous drive to detect a flexible drive member approaching the end of its safe operating life.

### BACKGROUND OF THE INVENTION

Synchronous drives are used in a wide variety of devices and are commonly used in internal combustion engines to drive the valve timing camshaft(s) from the crankshaft such that the camshaft(s) turn once for every two revolutions of the crankshaft. Such synchronous drives include a pulley, such as a gear or sprocket, on the crankshaft and a pulley, such as a gear or sprocket, on the camshaft(s) which are synchronously linked by a flexible drive member, typically a belt or chain. Other pulley-driven devices can also be operated by the synchronous drive and the synchronous drive can also include other components, such as a tensioner which operates to reduce variations in the tension of the flexible drive member which occur during operation of the drive and/or to compensate for the elongation of the flexible drive member which occurs with use and wear.

The failure of the synchronous drive in internal combustion engines prevents operation of the engine and can, in many engine designs, result in serious engine damage when pistons contact valves, etc. The most common failure mode for a synchronous drive is the failure of the flexible drive member due to wear and/or aging and engine manufacturers typically specify the replacement of the flexible drive member at predetermined intervals to avoid such failures.

However, the probability of the failure of a flexible drive member is generally not directly related to vehicle mileage or engine operating hours and there is no indicator of the actual condition of the flexible drive means that is easily available to service personnel. Thus, such manufacturer suggested predetermined intervals must generally be based upon worst-case scenarios and typically are overly pessimistic. This often results in the unnecessary replacement of the flexible drive member, with the commensurate expense.

It is known that one indication of the condition of a flexible drive member is the amount by which it has elongated (i.e. —stretched) from its original manufactured length but, for a variety of reasons, it has not been practical to determine in situ the amount of elongation of the flexible drive member in most cases. Typically the flexible drive member is not readily accessible without costly disassembly of at least a portion of the internal combustion engine.

Published German Patent Application DE 101 55 199 A1 to Hansel discloses a system and method for the determination, in situ, of the amount of elongation of a flexible drive member in a synchronous drive by measuring the phase difference of the camshaft to the crankshaft. While the system taught in Hansel might be able to provide some indication of elongation of the flexible drive member in ideal circumstances, in most circumstances torsional vibrations (the accelerations and decelerations of the flexible drive member due to the firing of pistons and the varying loads of the valve train, etc.) will mask the phase differential which is a result of the elongation of the flexible drive means. These torsional vibrations result in widely varying tension levels in the flexible drive member and can result in momentary phase differences between the camshaft and crankshaft which overwhelm the phase differences which result from the elongation of the flexible drive means due to wear and/or aging.

Published German application DE 10 2005 008 580 A1 to Spicer et al., assigned to the assignee of the present invention, discloses a tensioner system for a synchronous drive wherein the tensioner includes a sensor that outputs a signal indicating the position of the tensioner pulley along its eccentric and thus, provides an indication of the tension of the flexible drive member and/or the length of the flexible drive member. While the tensioner system taught in this application can provide an indication of the length of the flexible drive member, the tensioner system is necessarily located on the slack side of the flexible drive member. Because it is located on the slack side, the inherent dampening of flexible drive members which are rubber belts and, to a lesser extent chains, can in some cases reduce the overall resolution which the tensioner system can achieve.

While references such as published PCT Patent Application WO 2006/045181 to Cleland et al. teach methods for measuring, in situ, changes in the tension of a flexible drive member to detect engine resonance or other undesired operating conditions, such systems have not disclosed a method or system by which the degree of elongation of the flexible drive member can be reliably or very accurately determined in situ.

### SUMMARY OF THE INVENTION

It is an object of the present invention to provide a novel system and method of determining elongation of a flexible drive member in a synchronous drive which obviates or mitigates at least one disadvantage of the prior art.

According to a first aspect of the present invention, there is provided a system for determining the condition of a flexible drive member from the relative angular position of a first pulley with respect to a second pulley linked to the first pulley by the flexible drive member, the system comprising: a first sensor for determining the angular position of the first pulley; a second sensor for determining the angular position of the second pulley; a processing means responsive to a signal from the first sensor to obtain angular position determinations from the second sensor at selected intervals over at least one revolution of the second pulley, the processing means comparing the obtained angular position determinations to corresponding ones of a stored set of determined angular position determinations to determine an operating condition of the flexible drive member.

Preferably, the elongation of the flexible drive member from a pre-defined nominal length is employed to determine the operating condition of the flexible drive member. More preferably, the rate over time at which elongation of the flexible drive member from the pre-defined nominal length occurs is employed to determine the operating condition of the flexible drive member.

According to another aspect of the present invention, there is provided a system for determining the relative angular position of a camshaft with respect to a crankshaft in an internal combustion engine where the crankshaft is linked to the camshaft by a flexible drive member, the system comprising: a first sensor for determining the angular position of the crankshaft; a second sensor for determining the angular position of the camshaft; a processing means responsive to a signal from the first sensor to obtain angular position determinations of the camshaft from the second sensor at selected intervals over at least one revolution of the camshaft, the processing means comparing the obtained angular position determinations of the camshaft to corresponding ones of a stored set of determined angular position determinations to determine an operating length of the flexible drive means.

According to yet another aspect of the present invention, there is provided a method of determining the length of a flexible drive member synchronously linking a camshaft to a crankshaft of an internal combustion engine, comprising the steps of: making an initial determination of the length of the flexible drive member by determining the relative angular positions of the crankshaft and the camshaft at least two angular positions of the crankshaft in a complete revolution of the camshaft and storing at least one value defining the initial determination; at selected times during operation of the engine, making a determination of the current length of the flexible drive member by determining the relative angular positions of the crankshaft and the camshaft at the same at least two angular positions of the crankshaft used to determine the initial determination and producing the at least one value defining the determination of the current length; comparing the at least one value defining the determination of the current length to the at least one stored value defining the initial length to determine if the difference between the at least one value defining the determination of the current length and the at least one stored value defining the initial length exceeds a predetermined value representing a permitted elongation; and outputting a signal if the predetermined value is exceeded.

The present invention provides a system and method for determining changes in the angular position of a first pulley, with respect to a second pulley, when the first and second pulleys are synchronously linked by a flexible drive member such as a toothed belt or a chain. From these determined changes in the angular positions, the system and method can determine changes in the length of the flexible drive member, and thus the condition of the flexible drive member, and can output an appropriate signal when the condition of the flexible drive member has exceed a pre-defined value. Further, the system and method can detect a variety of other undesired conditions in the operation of an engine and/or the relative angular position information can be used to alter operation of the engine to improve the engine's operating efficiency and/or reduce the emissions created during operation of the engine.

### BRIEF DESCRIPTION OF THE DRAWINGS

Preferred embodiments of the present invention will now be described, by way of example only, with reference to the attached Figures, wherein:

FIG. 1 shows a schematic representation of a synchronous drive system in accordance with the present invention; and

FIG. 2 shows a plot of angular displacement of the driven pulley of the synchronous drive of FIG. 1 with respect to the driving pulley of the synchronous drive of FIG. 1.

### DETAILED DESCRIPTION OF THE INVENTION

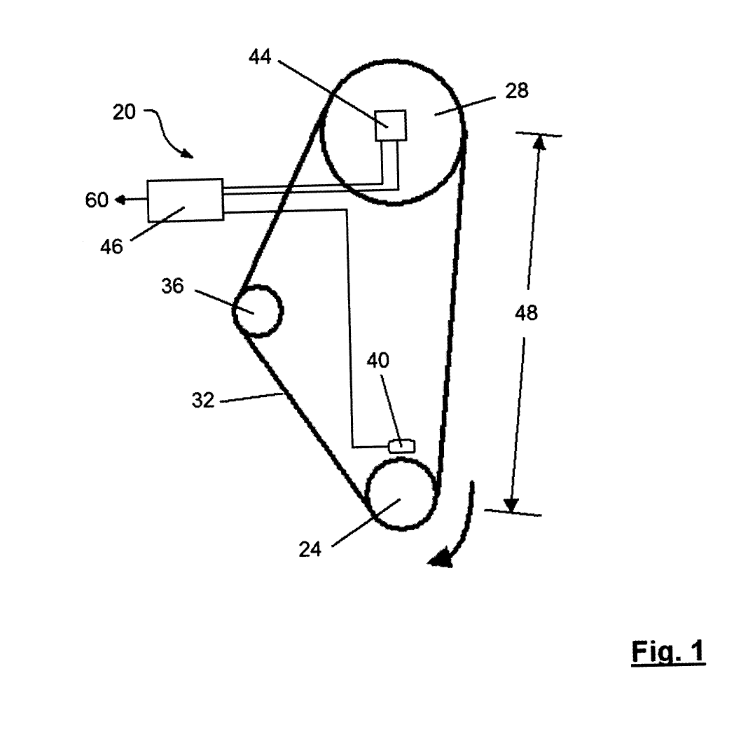

A synchronous drive for an internal combustion engine or the like is illustrated schematically at 20 in FIG. 1. Synchronous drive 20 includes a driving pulley 24 which can be, for example, mounted to the crankshaft of an engine and a driven pulley 28 which can be, for example, mounted to a camshaft of the engine. Driving pulley 24 and driven pulley 28 are synchronously linked by a flexible drive member 32, which is typically in the form of a toothed belt or chain.

Driving pulley 24 and driven pulley 28 are typically provided with teeth or grooves to engage complementary features such as ribs or rollers in flexible member 32 to ensure that rotation of driven pulley 28 is synchronous with that of driving pulley 24. As illustrated, driven pulley 28 on the engine camshaft has twice the diameter (and twice the number teeth or grooves) as driving pulley 24 on the engine crankshaft and thus driven pulley 28 makes one complete revolution for each two revolutions of driving pulley 24.

Many synchronous drives 20 will include other components, such as a tensioner 36 which is resiliently biased against flexible drive member 32 to maintain tension in flexible drive member 32 and to reduce the magnitude of torsional vibrations in flexible drive member 32.

To control the operation of the engine of which synchronous drive 20 operates, a sensor 40 is typically located near the engine crankshaft adjacent driving pulley 24 and sensor 40 provides a signal indicating the angular position of the engine crankshaft, typically relative to a Top Dead Center (TDC) position, to the Engine Control Unit (ECU) which uses this position information for fuel injection and ignition timing purposes.

Typically, sensor 40 comprises at least one Hall Effect or other sensor which responds to the movement of teeth on a toothed wheel on the crankshaft past sensor 40 to generate a series of electrical pulses which the ECU will use as an input to its control algorithms.

In the present invention, a sensor 44 is also employed to determine the position of driven pulley 28. While sensor 44 need not be able to determine the angular position of driven pulley 28 with a high degree of absolute accuracy, it is desired that the systematic error in the output signals from sensor 44 be consistent for each revolution of driven pulley 28 as the present invention examines the change between a current set of obtained data for a revolution and a calibration set of data for a revolution to determine the degree of change in the angular position of driven pulley 28 with respect to the angular position of driving pulley 24.

In other words sensor 44 can, for example, produce an output signal showing driven pulley 28 leading its actual angular position over some part of a revolution of driven pulley 28 and lagging its actual angular position for the remainder of the revolution of driven pulley 28 without affecting the accuracy of the determination of the elongation of flexible drive member 32, provided only that the leading and lagging errors in the output signal are substantially constant between revolutions of driven pulley 28.

Accordingly, sensor 44 can be any suitable sensor, such as a Hall Effect sensor similar to that of sensor 40 and a toothed wheel associated with driven pulley 28, although it Is presently preferred that sensor 44 be similar to the absolute angular position sensor taught in published PCT application WO/2006/045186 and/or in published PCT application WO/2006/045184, each of which are assigned to the assignee of the present invention and the contents of these published applications are incorporated herein by reference. As is described below, the use of such an absolute position sensor allows the present invention to make a variety of other useful determinations, if desired.

While sensor 44 is necessary for the present invention, it is contemplated that sensor 44 can also be used for a variety of other conventional engine control purposes such as providing a necessary input for a variable valve timing (WT) control system, etc. and thus the incremental cost of providing sensor 44 can be negligible or even zero in cases where such a sensor must be provided for other purposes such as VVT control. Similarly, a sensor 40 is generally already provided for most engines and thus the incremental cost of providing sensor 40 can be negligible or even zero.

As is known, as flexible drive member 32 ages and/or wears, it elongates. One of the results of this elongation is that the spacing between the ribs (in the case of a flexible belt) or rollers (in the case of a chain) increases and thus the angular position of driven pulley 28 will alter with respect to the angular position of driving pulley 24 as flexible member 32 elongates. Specifically, as the spacing between the ribs or rollers of flexible drive member 32 increases, the angular position of driven pulley 28 will lag the angular position it had before the elongation occurred.

In the present invention, a determination of the angular position of driven pulley 28 with respect to the angular position of driving pulley 24 is performed at intervals (n) about at least one revolution of driven pulley 28 (and thus during at least two rotations of driving pulley 24). When sensor 40 is a Hall Effect sensor, these intervals (n) can correspond to the pulses of the pulse train output by the sensor. In a typical engine, when sensor 40 is a Hall Effect sensor sensing a toothed wheel, sensor 40 produces sixty four pulses (there being sixty four teeth on the toothed wheel attached to the crankshaft which sensor 40 reads) through a complete rotation of driving pulley 24 and one hundred and twenty eight pulses through the two complete revolutions of driving pulley 24 required to perform one complete revolution of driven pulley 28.

If sensor 40 outputs one hundred and twenty eight pulses per complete revolution of driven pulley 28, then the present invention can employ a corresponding one hundred and twenty eight intervals (n=128) or can define an interval by a greater number of pulses, e.g. —an interval every two pulses for n=64, or every four pulses for n=32, etc.

If sensor 40 is an absolute position sensor, such as that described in published PCT application WO/2006/045186 and/or in published PCT application WO/2006/045184, then the intervals can be defined by positions of driving pulley 24. For example, if it is desired to have n=16 intervals, then each interval is defined by the movement of driven pulley 24 through twenty-two and a half degrees of revolution. Similarly, if it is desired to have n=128 intervals, then each interval is defined by the movement of driven pulley 24 through two point eight one two five degrees of revolution.

As should be apparent to those of skill in the art, it is not essential in the present invention for the intervals to be equi-spaced about a revolution of driven pulley 28, provided only that the intervals employed be consistent between revolutions of driven pulley 28. For example if the first interval (n=1) occurs at three degrees of revolution of driven pulley 28 from an arbitrary index position, the second interval (n=2) can occur at five degrees of revolution of driven pulley 28 from the first interval, etc. subject only to the condition that on each revolution of driven pulley 28 interval n=1 occurs at three degrees of revolution from the index position and the second interval occurs at five degrees of revolution from the first interval, etc.

As will be apparent to those of skill in the art, an appropriate number of intervals can be selected depending upon the order of the significant torsional vibrations in synchronous drive 20. In a present embodiment, it has been determined that a minimum of n=8 intervals are performed for each revolution of driven pulley 28, although higher values of intervals n are generally preferred to increase the accuracy of the obtained results. In a present embodiment of the invention, a determination is made of the angular position of driven pulley 28 at each of the one hundred and twenty eight pulse positions of driving pulley 24 and thus n=128.

If sensor 40 produces a pulse train of pulses as its output, these pulses can be used like clock signals to ECU 46 which processes the output of sensor 44 to determine the angular position of driven pulley 28 at each pulse n of interest and thus, when n=128, ECU 46 determines the relative angular position of driven pulley 28 one hundred and twenty eight times per revolution.

When sensor 44 comprises an absolute position sensor, each determination is achieved by sampling the output of sensor 44 at the appropriate interval n, as indicated by sensor 40, and converting the sampled output voltage, or voltages, from sensor 44 into an angular position for driven pulley 28. As the angular position of driving pulley 24 is known from the output of sensor 40, the relative angular position of driven pulley 28 with respect to driving pulley 24 can easily be determined from:

Relative Angular Position(n)=Driving Pulley Position(n)−Driven Pulley Position(n)

It is contemplated that the ECU 46 for the engine on which synchronous drive 20 is installed can process the signals obtained from sensor 40 and from sensor 44, as described above. Provided that ECU 46 has the necessary processing capacity and has sufficient memory to store the values discussed below, the ECU program can be updated to perform the method of the present invention, avoiding the need for an additional microprocessor device. However, it is also contemplated that such an additional microprocessor device can be employed, if desired or required, and the construction or selection of such a suitable device will be apparent to those of skill in the art. In the discussion herein, it is assumed that ECU 46 has sufficient processing capacity and has been appropriately programmed to perform the necessary steps of the present invention.

As will be apparent, changes in the relative angular position between driving pulley 24 and driven pulley 28 at an interval (n) on one revolution of driven pulley 28 and the relative angular position between driving pulley 24 and driven pulley 28 on another revolution of driven pulley 28 results from changes in the length 48 of the tension side of flexible drive member 32.

These changes in length 48 occur both as a result of elongation of flexible member 32 as it ages and/or wears over time, and also as a result of torsional vibrations transmitted through flexible drive member 32 to and from driving pulley 24, driven pulley 28 and other devices connected by synchronous drive 20.

It is believed that the prior art Hansel system, described above, did not produce satisfactory or reliable results for a variety of reasons, but perhaps most significantly because it could not distinguish between an overall elongation of flexible drive member 32 due to wear and/or aging and the transient elongations due to tension changes in flexible drive member 32 due to torsional vibrations.

In contrast, as described in more detail below, the present invention can make this distinction and is thus able to determine the amount of the elongation of flexible drive member 32 due to wear and/or aging. As is also described below, the present invention can provide a variety of other useful information.

It is a simple matter for the designer of synchronous drive 20 to equate relative angular position to an amount of elongation of flexible drive member 32, by considering the geometry of the positions of driving pulley 24 and driven pulley 28. It is contemplated that, typically, the designer will derive a maximum relative angular position difference that can be tolerated from a maximum elongation tolerance measurement for flexible drive member 32 and that this derived maximum relative angular position difference will be used as a test value for ECU 46 to generate suitable outputs such as “service engine soon” indicator signals, etc.

When a new flexible drive member 32 is installed on flexible drive 20, such as at the initial assembly of the engine or when the replacement of flexible drive member 32 has been mandated for any reason, a reference, or calibration, set of data is obtained to calibrate synchronous drive 20. Specifically, for each interval (n) of at least one revolution of driven pulley 28, the relative angular position of driven pulley 28 to driving pulley 24 will be determined.

As mentioned above, the effects of torsional vibrations on flexible drive member 32 can obscure the determination of the length of flexible drive member 32 by tensioning and/or de-tensioning flexible drive member 32 on a transient basis. Accordingly, in the present invention it has been found preferable to determine the relative angular position between driven pulley 28 and driving pulley 24 over n intervals about a revolution of driven pulley 28 to reduce the effects of such transient changes. It is also contemplated that, if desired, the present invention can determine the relative angular position between driven pulley 28 and driving pulley 24 over n intervals over more than a single revolution of driven pulley 28. For example, the determination of the relative angular position between driven pulley 28 and driving pulley 24 can be performed for each of n intervals over three or four revolutions of driven pulley 28 if the resulting increased accuracy is desired, although it has been found that acceptable results can be obtained when considering a single revolution.

To reduce the masking effects of torsional vibrations, the present invention filters the n determinations of the relative angular position of driven pulley 28 to driving pulley 24. In the simplest embodiment, the values for each determined relative angular position are merely summed together to produce a single value which can be used for comparison purposes, as described below. However, as should be apparent to those of skill in the art, a wide variety of other filtering operations can be employed, including calculating averages, means, etc. if desired.

The calibration data set is obtained with the engine operating at a known selected set of engine operating conditions, such as an engine operating speed of six hundred rpm with the engine at normal operating temperature, no valve phasing (for VVT systems) and the engine being in a no load condition.

Once a calibration data set, which can be a single value or which can be the values for each interval n, has been obtained, etc. the present invention can be employed to detect elongations of flexible drive member 32.

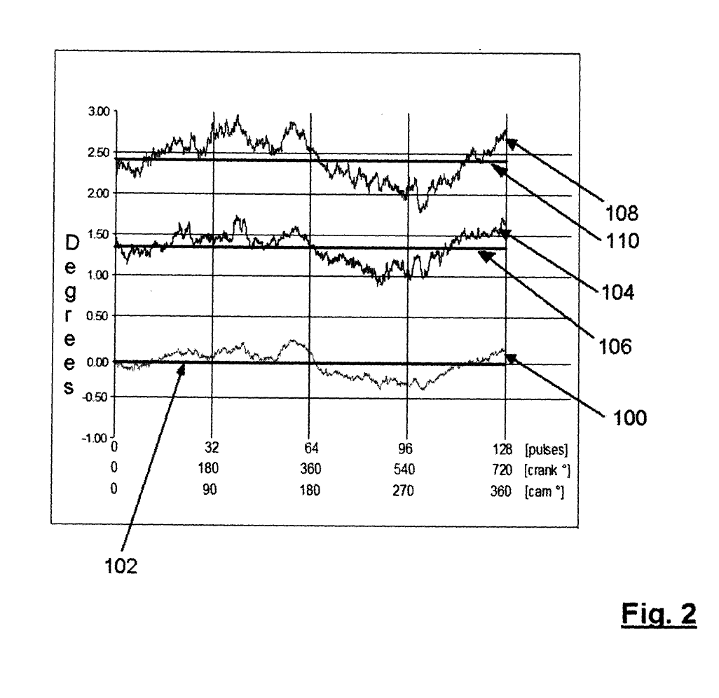

An example of the calibration data set values obtained in this manner is shown as curve 100 in FIG. 2, wherein n=128 and the values have been normalized about zero degrees relative angular position. These values represent the angular position of driven pulley 28, relative to the angular position of driving pulley 24 and can be leading (denoted by negative values in the convention used in this example) or lagging (denoted by positive values in the convention used in this example).

The solid flat line 102 associated with curve 100 represents a filtered calibration value derived from the calibration data of curve 100. In the illustrated example, the value of line 102 is determined by averaging the one hundred and twenty eight obtained data values obtained during calibration and, as can be seen, value 102 for curve 100 is deemed to be 0.0 degrees (as a result of the normalization). Once the set of calibration values have been obtained (whether multiple individual values or a single derived value), they are stored in ECU 46 or in another suitable storage device for the engine.

It is contemplated that the calibration routine can be performed when necessary, by placing ECU 46 into a calibration mode via an appropriate scan tool, such as those used by service personnel, or via any other suitable means as will occur to those of skill in the art.

When the engine on which synchronous drive 20 is in normal use, ECU 46 will periodically check the elongation of flexible drive member 32. Specifically, at intervals pre-selected by the manufacturer of the engine, ECU 46 will await (or induce) the next occurrence of the engine being operated at similar selected conditions as the set of calibration values were obtained at.

Using the example given above, this means that ECU 46 will await the next time the engine is operating at about 600 rpm, at normal operating temperature, and under a no load condition, such as with the transmission being in Neutral or Park. Alternatively, ECU 46 can proactively induce the desired operating conditions by, for example, disengaging an air conditioner clutch to remove the load from the engine when the engine would otherwise be operating at the selected conditions and/or changing the engine idle speed by varying the throttle. Once ECU 46 has acquired the data it needs at the selected operating conditions, ECU 46 can reengage the air conditioner clutch, etc.

As will be apparent to those of skill in the art, ECU 46 can be programmed to control a variety of other functions to induce the engine to operate at the selected conditions.

When ECU 46 determines that the engine is operating with the selected conditions, a set of relative angular position data for at least revolution of driven pulley 48 is obtained. Specifically, for each interval n, a determination of the angular position of driven pulley 28 is made from the output of sensor 44. The obtained values are then filtered with the same filtering process (if any) used to obtain the calibration data set values and are compared to the calibration data set values previously obtained.

A set of angular position values obtained in this manner at a specified set of operating conditions is shown as curve 104 in FIG. 2 and line 106 represents a single filtered value derived from curve 104. As can be seen from curves 100 and 104 (and/or from single values 102 and 106), at the time the data of curve 104 was obtained, driven pulley 28 was lagging (indicated by a positive value) driving pulley 24 by about one point four degrees which may, for example, equate to an elongation of flexible drive member 32 of one millimeter. Curve 108 in FIG. 2 represents a set of angular position values obtained at a time subsequent to those of curve 104 and line 110 represents a single filtered value derived from curve 108. As can be seen, driven pulley 28 is lagging driving pulley 24 by about two point four degrees at this time which may, for example, equate to an elongation of flexible drive means 32 of one and a half millimeters.

As will be apparent to those of skill in the art, the actual timing of when the present invention examines the elongation of flexible drive member 32 is not particularly limited and can be defined in a variety of manners. For example, the engine manufacturer can define the times as occurring after a selected number of engine starting events (i.e. —after every twenty five starts of the engine), after a specified mileage or number of operating hours has occurred (i.e. —after every one thousand miles or after every fifty hours of engine operating time), etc. In each of these examples, the determination of the angular position of driven pulley 28 is made the next time the engine is operated at the desired operating parameters (i.e. —those used when obtaining the calibration data). It is also contemplated, and presently preferred, that the timing can be specified as every time the engine is operated at the desired operating parameters.

When ECU 46 determines that the determined relative angular position (and/or its corresponding elongation) of driven pulley 28 exceeds a maximum value specified by the manufacturer of the engine, ECU 46 will output an appropriate signal 60. Signal 60 can be as simple as an electrical signal which causes a “SERVICE ENGINE SOON” indicator to be illuminated on the dashboard of the vehicle and/or can be a signal which alters the operation of the engine to inhibit failure of flexible drive member 32 until synchronous drive 20 is serviced. Specifically, in this latter case, ECU 46 can respond to signal 60 to limit the engine operating speed, engine output, etc. until a detected degraded flexible drive member 32 has been replaced.

While, as mentioned above, the elongation of flexible drive member 32 from a nominal manufactured length can provide a reasonable indication of the condition of flexible drive member 32, it is believed that the present invention can provide different and/or better indications of the condition of flexible drive member 32. For example, as is apparent, the overall amplitude of curve 108 is greater than that of curve 104 and this increased amplitude can provide another indication of the condition of flexible drive means 32. Accordingly, in addition to, or instead of, comparing a determined angular position of driven pulley 28 to a calibration data set, ECU 46 can compare the amplitude of the obtained angular positions and can output signal 60 when the amplitude exceeds a specified value.

More preferably, ECU 46 will compare both the amount of angular position lag and the amplitude of variations in the angular position to predetermined values and will output signal 60 when either these values are exceeded.

Another test of the condition of flexible drive member 32 is a consideration of the rate at which flexible drive member 32 is elongating and it is believed that this test can provide a better indication of the condition of flexible drive member 32. Specifically, as flexible drive member 32 ages and/or wears and approaches the end of its safe operating lifetime, it will tend to elongate at a faster rate than it elongated at the earlier times in its operating lifetime. Accordingly, ECU 46 can store data indicating the rate at which flexible drive member 32 is elongating and can output signal 60 once this rate exceeds a value predefined by the manufacturer of the engine. In such a case, ECU 46 can store several values such as the filtered single values (106 or 110) representing a determined angular position and a relevant respective timestamp indicating when each value was obtained.

When ECU 46 next obtains a filtered single value of a determined angular position, this value can be compared to the stored values and their respective timestamps (which can be expressed in engine operating hours, time, engine start operations or any other relevant time reference) and if ECU 46 determines that a pre-specified amount of elongation has occurred within a pre-specified amount of time, then ECU 46 can produce signal 60 to indicate that flexible drive member 32 requires replacement.

In addition to determining the condition of flexible drive member 32 by determining the amount of elongation and/or the rate at which the elongation is occurring, the present invention can also provide a more direct indication of the condition of belts which are employed as flexible drive member 32. Specifically, as a flexible belt degrades over time, small pieces of the ribs of the belt can break free of the belt and/or cords in the belt can fray and unravel. In both of these cases, it is common for rib material and/or cord materials to be caught between the inner surface of flexible drive member 32 and the surface of one or both of driving pulley 24 and driven pulley 28. When such foreign objects pass between the inner surface of flexible drive member 32 and driving pulley 24 or driven pulley 28, the diameter of the respective pulley is effectively increased resulting in a temporary apparent shortening of flexible drive member 32.

Accordingly, ECU 46 can, either at specified intervals or on an ongoing basis, compare the determined angular position of driven pulley 28 to detect changes which indicate a shortening of flexible drive member 32. If a shortening of more than a pre-specified amount and/or for more than a pre-specified period of time is detected, then ECU 46 can output signal 60, or a similar signal, to identify that an undesired condition exists and that synchronous drive 20 requires service.

Also, as flexible belts age and/or wear, the rubber materials of which they are constructed can stiffen and this stiffening can be another indicator that the belt is approaching, or is at, the end of its safe operating lifetime. This stiffening can be detected by ECU 46 from examining the amplitude, and/or other data characteristics, of data values in curves 104 and 108 or the like.

As should now be apparent to those of skill in the art, in addition to providing information with respect to the condition of flexible drive member 32, in the present invention ECU 46 will also know the angular position of driven pulley 28, with respect to driving pulley 24 with a higher degree of accuracy than in many prior art engines. Accordingly, ECU 46 can adjust fuel injection timing, ignition timing and/or variable valve timing in view of this more accurate information to improve engine operation, improve combustions and/or reduce emissions.

In such a case, the determination of the angular position of driven pulley 28 can be performed on an ongoing basis for engine control purposes, but this data will only be considered for determining the elongation of flexible drive member 32, as described above, when the engine is operating at the specified parameters used to obtain the calibration data.

As should also be apparent to those of skill in the art, as an added benefit the present invention can be employed to monitor the operation of synchronous drive 20 and/or other engine components. For example, the amplitude of unfiltered sets of angular positions of driven pulley 28 can be considered by ECU 46 to determine the magnitude of the torsional vibrations occurring in the engine. If the determined levels of torsional vibrations indicate an undesired operating condition, such as an engine resonance condition, ECU 46 can change the operation of the engine, engine subsystems or accessories to avoid the resonance.

Similarly, a failure of tensioner 36 or an idler or other component of synchronous drive 20 can also be detected by ECU 46 examining the amplitude, frequency or other statistical characteristics of the angular position data obtained for driven pulley 28. For example, statistical analysis such as probability density functions, means, standard deviations, etc. as will occur to those of skill in the art, can be employed to obtain useful information regarding the operation and condition of synchronous drive 20 and the engine it is installed on.

Further, in the event that tensioner 36 or another component of synchronous drive 20 fails, or operates improperly, it is possible that flexible drive means 32 can experience a “tooth skip” wherein flexible drive member 32 rotates with respect to just one of driven pulley 28 or driving pulley 24. For example, it is not unknown for a belt to slip one or more grooves on driven pulley 28 or driving pulley 24 during a cold start of an engine if tensioner 36 is not operating properly. In such a case, the present invention will detect such a tooth skip as a sudden, relatively large increase in the elongation of flexible drive member 32. Accordingly, ECU 46 can operate at each engine startup to determine an amount of elongation of flexible drive member 32 and, if the determined amount of elongation exceeds a stored “tooth skip” value, an appropriate output signal 60 can be provided and can, for example, stop the engine or limit the operating conditions of the engine until synchronous drive 20 is serviced. In such a circumstance, the degree of elongation will exceed that which could be masked by torsional vibrations and thus it is not necessary to await the next occurrence of the engine operating at the same conditions as when the calibration data set was obtained.

Similarly, ECU 46 can employ the tooth skip value, or similar value, as a maximum elongation value and another pre-selected value as a minimum elongation value for a test against improper installation of flexible drive member 32. Specifically, if flexible drive member 32 is improperly installed with the relative angular positions of driven pulley 28 and or driving pulley 24 mis-aligned by one or more teeth, ECU 46 will determine that the length of flexible drive member 32 either exceeds the tooth skip test value or is less than the minimum length test value and can output an appropriate signal 60 to advise service personnel to correct the installation.

Further, while in much of the discussion above sensor 40 is a conventional Hall Effect sensor, if both sensor 40 and sensor 44 are absolute position sensors then the present invention can provide another advantage in that the relative angular positions of driving pulley 24 and driven pulley 28 can be determined with the engine in a stopped condition as, unlike Hall Effect sensors, these absolute position sensors do not require movement of the measured components to provide meaningful angular position information. Thus, a static elongation measurement of flexible drive member 32 can be performed which will not be subject to transient errors from torsional vibrations. Further, the above mentioned tooth skip and/or mis-installation tests can be performed prior to rotating the engine which could otherwise result in damage to engine components if a tooth skip condition has occurred.

While much of the discussion above assumed that sensor 40 was a Hall Effect sensor and sensor 44 was an absolute position sensor, the present invention is not so limited and sensor 44 can be a Hall Effect sensor, or the like, while sensor 40 can be a Hall Effect sensor or an absolute position sensor, provided only that the toothed wheel associated with sensor 44 in such a scenario have enough teeth to provide the required resolution (number of intervals n) and that the systematic error of the sensors be consistent enough to obtain sufficiently accurate angular position determinations.

Further, while the discussion above has only referred to a single sensor 44, it is contemplated that in dual camshaft engines, each camshaft can include a respective sensor 44 to allow a determination of the respective angular position of its respective driven pulley 28 with respect to driving pulley 24 and/or to the respective other driven pulley 28. In such a case ECU 46 can determine the change in length 48 between one camshaft and the crankshaft and can also determine the change in the length of flexible drive means 32 between the driven pulleys of the two camshafts.

By determining the changes in these two lengths, ECU 46 will have additional data concerning the condition of flexible drive means 32 and, with the determined angular position data for each camshaft, ECU 46 can also alter engine ignition timing, fuel injection timing and/or or variable valve timing accordingly to improve engine operations. Sensor 44 can alternatively be installed on any pulley on synchronous drive 20, such as on a driven pulley for a water pump, etc.

It is also contemplated that the present invention can provide a variety of other useful information if desired. For example, an analysis of the angular position data obtained by ECU 46 can detect possible failures, or improper operation, of engine components, such as tensioner 36, a coolant circulating pump, automatic transmissions, valve train components, such as sticking valves or weakened valve springs, etc. Also, ECU 46 can detect an eccentricity of driving pulley 24 or driven pulley 28 due to wear or poor manufacturing.

The present invention provides a system and method for determining changes in the angular position of a driven pulley, with respect to a driving pulley, when the driven and driving pulleys are synchronously linked by a flexible drive member such as a toothed belt or a chain. From these determined changes in the angular position, the system and method can determine the condition of the flexible drive member and can output an appropriate signal when the condition of the flexible drive member has exceed a pre-defined value. Further, the system and method can detect a variety of other undesired conditions in the operation of an engine and/or the relative angular position information can be used to alter operation of the engine to improve the engine's operating efficiency and/or reduce the emissions created during operation of the engine.

The above-described embodiments of the invention are intended to be examples of the present invention and alterations and modifications may be effected thereto, by those of skill in the art, without departing from the scope of the invention which is defined solely by the claims appended hereto.

1. A system for determining the condition of a flexible drive member from the relative angular position of a first pulley with respect to a second pulley linked to the first pulley by the flexible drive member, the system comprising:
a first sensor for determining the angular position of the first pulley;
a second sensor for determining the angular position of the second pulley;
a processing means operable to obtain angular position determinations from the first sensor and the second sensor at selected intervals over at least one revolution of the second pulley, the processing means comparing the obtained angular position determinations to at least one corresponding stored calibration relative angular position to determine an operating condition of the flexible drive member.

2. The system of claim 1 wherein the angular position determinations are obtained from the second sensor when the operating conditions of the system are substantially similar to those of the system when the stored set of calibration relative angular positions was obtained.

3. The system of claim 1 wherein the stored set of calibration relative angular positions is produced by obtaining angular position determinations from the second sensor at least eight known intervals in a complete revolution of the second pulley.

4. The system of claim 3 wherein the stored set of calibration relative angular positions comprises a single value obtained by filtering a set of obtained relative angular position determinations and the obtained angular position determinations are processed by a similar filtering operation to obtain a single value to be compared to the stored set of calibration relative angular positions.

5. The system of claim 4 wherein the filtering comprises summing the obtained angular position determinations to obtain the single value.

6. The system of claim 4 wherein the filtering comprising determining an average from the obtained angular position determinations to obtain the single value.

7. The system of claim 1 wherein the determined operating condition of the flexible drive member comprises a determination of the elongation of the flexible drive member from a nominal length.

8. (canceled)

9. (canceled)

10. (canceled)

11. (canceled)

12. (canceled)

13. (canceled)

14. (canceled)

15. The system of claim 1 wherein the selected intervals are not equi-spaced over the at least one revolution of the second pulley.

16. (canceled)

17. (canceled)

18. (canceled)

19. The system of claim 1 wherein the operating condition of the flexible drive member is determined at least three instances and the rate of change of the operating condition of the flexible drive member over the at least three instances is determined and is compared to a predefined acceptable rate and wherein the system generates an output signal when the rate of change exceeds the predefined acceptable rate.

20. The system of claim 1 wherein the amplitudes of the changes of the relative angular positions at the intervals are determined and are compared to a predefined acceptable amplitude and wherein the system generates an output signal when the amplitudes exceeds the predefined acceptable amplitude.

21. The system of claim 1 where, when the relative angular positions indicate a shortening of the length of the flexible drive means, the system outputs a signal indicating that foreign material is between the flexible drive member and the surface of a pulley.

22. The system of claim 1 wherein the first sensor and the second sensor are absolute position sensors and wherein the relative angular position between the first pulley and the second pulley is determined at a single interval when the engine is stopped.

23. A system for determining the relative angular position of a camshaft with respect to a crankshaft in an internal combustion engine where the crankshaft is linked to the camshaft by a flexible drive member, the system comprising:
a first sensor for determining the angular position of the crankshaft;
a second sensor for determining the angular position of the camshaft;
a processing means responsive to a signal from the first sensor to obtain angular position determinations of the camshaft from the second sensor at selected intervals over at least one revolution of the camshaft, the processing means comparing the obtained angular position determinations of the camshaft to corresponding ones of a stored set of determined angular position determinations to determine an operating length of the flexible drive means.

24. The system of claim 23 wherein the first sensor and the second sensor are absolute position sensors responsive to rotation of a toothed wheel on the crankshaft and outputting a pulse train representing the angular position of the crankshaft.

25. (canceled)

26. The system of claim 24 wherein the pulse train acts as a clock signal to the processing means, the processing means determining the angular position of the camshaft each time at least one pulse is received.

27. A method of determining the length of a flexible drive member synchronously linking a camshaft to a crankshaft of an internal combustion engine, comprising the steps of:
making an initial determination of the length of the flexible drive member by determining the relative angular positions of the crankshaft and the camshaft at least two angular positions of the crankshaft in a complete revolution of the camshaft and storing at least one value defining the initial determination;
at selected times during operation of the engine, making a determination of the current length of the flexible drive member by determining the relative angular positions of the crankshaft and the camshaft at the same at least two angular positions of the crankshaft used to determine the initial determination and producing the at least one value defining the determination of the current length;
comparing the at least one value defining the determination of the current length to the at least one stored value defining the initial length to determine if the difference between the at least one value defining the determination of the current length and the at least one stored value defining the initial length exceeds a predetermined value representing a permitted elongation; and
outputting a signal if the predetermined value is exceeded.

28. The method of claim 27 where the initial determination and the determination of the current length are each performed at least eight angular positions of the crankshaft during one revolution of the camshaft.

29. The method of claim 27 wherein the first sensor and the second sensor are absolute position sensors and where the initial determination and the determination of the current length are each performed at one angular position of the crankshaft with the engine stopped.

30. The method of claim 27 wherein the output signal activates a warning signal.

31. The method of claim 27 wherein the output signal alters the operation of the engine to decrease the chance of engine damage occurring due to the elongation.
